(19) United States
(12) Patent Application Publication
(10) Pub. No.: US 2003/0093756 A1
(43) Pub. Date: May 15, 2003

(54) Extensible mark-up language (XML) tracer for conversion of XML documents to hypertext markup language (HTML)

(76) Inventors: Azad E. Behzadi, Los Angeles, CA (US); John Li, Foothill Ranch, CA (US); Michael Teng, Irvine, CA (US); Derek Yang Shen, Culver City, CA (US)

Correspondence Address: KENYON & KENYON, One Broadway, New York, NY, 10004, US

(21) Appl. No.: 10/273,656

(22) Filed: Oct. 18, 2002

Related U.S. Application Data
(60) Provisional application No. 60/345,104, filed on Oct. 19, 2001.

(51) Int. Cl. G06F 17/21

(52) U.S. Cl. 715/501.1; 715/513

(57) ABSTRACT

A system and method for conversion of a XML document to a HTML document such that the HTML document is traced back to the original XML document. A recipient views the converted XML document as a HTML document and then makes changes to the HTML document. The changes made by the recipient are incorporated into the HTML document as it is traced, i.e., converted, back into the original XML document.

### RELATED APPLICATIONS

This application claims the benefit under 35 U.S.C. §119(e) of U.S. provisional application Serial No. 60/345,104, filed Oct. 19, 2001, the contents of which are incorporated herein by reference.

### FIELD OF THE INVENTION

The present invention relates to a system and method for electronic data exchange.

### BACKGROUND INFORMATION

Hypertext Markup Language (HTML) is the standard for displaying data over the Internet. HTML focuses on data format by providing a set of markup tags for formatting data contained within a HTML document.

Extensible Markup Language (XML) is a markup language that is similar to Hypertext Markup Language (HTML). XML is the standard for data transfer over the Internet. XML is specifically configured to describe data and it allows authors of electronic documents to define their own markup tags and document structure.

HTML documents use predefined markup tags and the meanings of these tags are defined by the HTML standard. For example, the <p> tag indicates a paragraph and the <h1> indicates a header with certain predefined attributes such as font size and alignment. An Internet browser interprets these markup tags to display data to recipients as a web page. With XML, users are able to create markup tags for their specific purposes. For example, a user of XML may create a markup tag called <weather> to describe data relating to weather. The user defined markup tags in XML may not be understandable to the Internet browser. Due to the nature of XML, there is no standard way to display a XML document.

Other systems provide for conversion of XML documents to HTML documents for display purposes. These systems have not addressed the conversion of HTML documents back to XML documents. Cascading Style Sheets (CSS) or Extensible Stylesheet Language (XSL) may be used to define how the XML document should be displayed by the Internet browser. CSS is a computer language that allows users to define the style, i.e., fonts, coloring, spacing, etc., of structured documents such as HTML documents and XML documents. With XSL, the XML document is converted into a format, i.e. HTML, that is understandable to the Internet browser. XSL is used to convert each XML markup tag into a HTML markup tag.

### SUMMARY OF THE INVENTION

The system and method according to the present invention provide for conversion of a XML document to a HTML document such that the HTML document may be traced back to the original XML document. A recipient views the converted XML document as a HTML document and then makes changes to the HTML document. The changes made by the recipient are incorporated into the HTML document as it is traced, i.e., converted, back into the original XML document. The system and method according to the present invention may be applied to display XML documents over communications networks, i.e. the Internet and local area networks.

Exemplary embodiments of the present invention are shown in the drawings and explained in the description which follows.

### BRIEF DESCRIPTION OF THE DRAWINGS

FIG. 1 shows an exemplary method according to the present invention.

FIG. 2 shows an exemplary system according to the present invention.

FIG. 3 shows an exemplary XML document prepared by a sender.

FIG. 4 shows an exemplary HTML document sent to the recipient.

FIG. 5 shows an exemplary traced XML document.

FIG. 6 shows an exemplary embodiment of a set of meta-data.

FIG. 7 shows the conversion of a XML markup tag and to a HTML markup tag.

### DETAILED DESCRIPTION

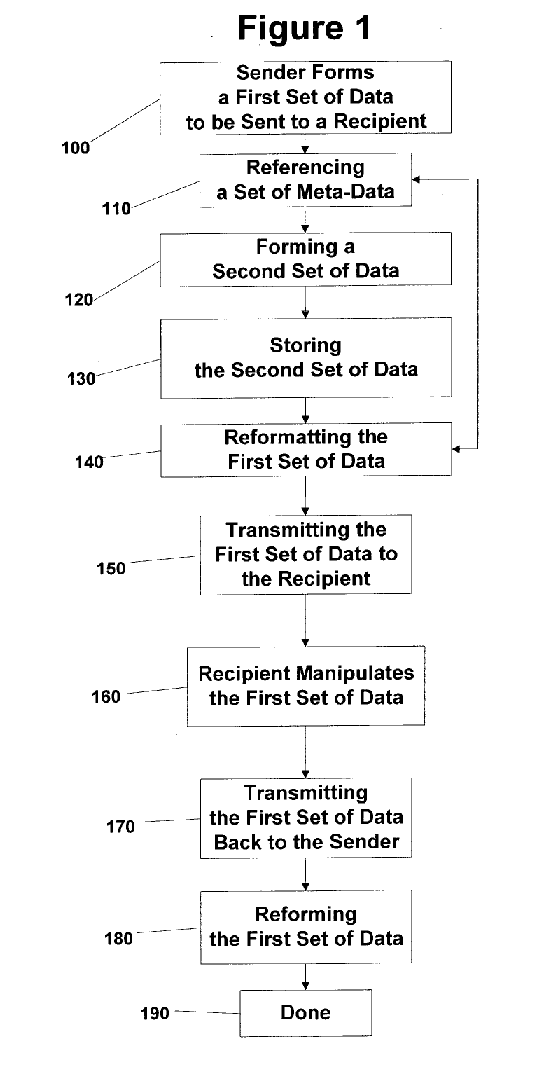

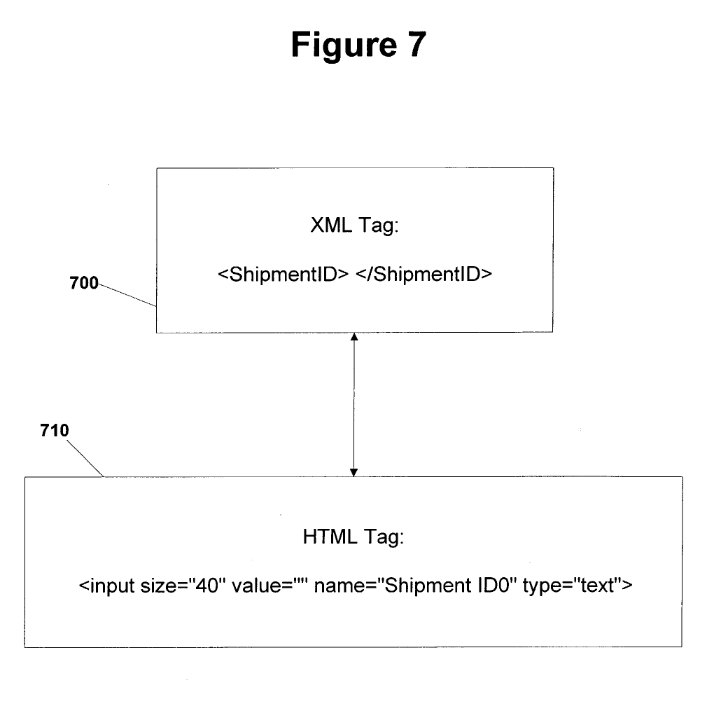

FIG. 1 shows the exemplary method according to the present invention. In step 100, a sender forms a first set of data as a XML document. In step 110, a set of predefined meta-data is referenced. The set of meta-data defines the manner in which the first set of data is displayed and how the first set of data may be manipulated. After referencing the set of meta-data, the second set of data loads and includes the set of meta-data. In step 120, by referencing the set of predefined meta-data, a second set of data is formed that includes data regarding the structure of the first set of data, data regarding a storage location of the first set of data, data regarding a storage location of the elements of the first set of data, and data regarding the values of the elements of the first set of data. In step 130, the second set of data is stored. The second set of data may be stored by saving it on a storage subsystem of a computer system, i.e. a web server session. In step 140, the first set of data is reformatted; this is accomplished by replacing the XML markup tags (i.e., data tags) with HTML markup tags on the basis of again performing step 110 and referencing the set of meta-data. As a result, the first set of data conforms to the HTML format standard. FIG. 7 shows the conversion of a XML markup tag to a HTML markup tag. In step 150, the first set of data is transmitted to a recipient. The transmission of the first set of data may be accomplished by using a computer arrangement that is in communication with a processor via a communications network. This processor may include a computer server arrangement. In step 160, the recipient manipulates the first set of data. A recipient views the first set of data as a HTML form and enters data using the form thus editing and changing the HTML document. In step 170, the recipient transmits the first set of data, after manipulating it and changing the values of the elements of the first set of data, back to the sender. In step 180, the first set of data is reformed as a XML document, i.e., traced back into a XML document, by replacing the HTML markup tags with XML markup tags on the basis of the second set of data. Changes to the values of the elements are taken in account in reforming the first set of data by referencing the second set of data that includes the values of the elements before the recipient manipulated the first set of data. The set of meta-data and the first set of data are combined with the data as changed by the recipient. In this manner, the HTML document is traced back to a new XML document that is similar to the first XML document created in step 100 but includes the changes to data made by the recipient. In step 190, the exemplary method according to the present invention is completed.

The exemplary method according to the present invention may be used for other types of presentation systems, besides HTML documents, e.g., windows GUI applications.

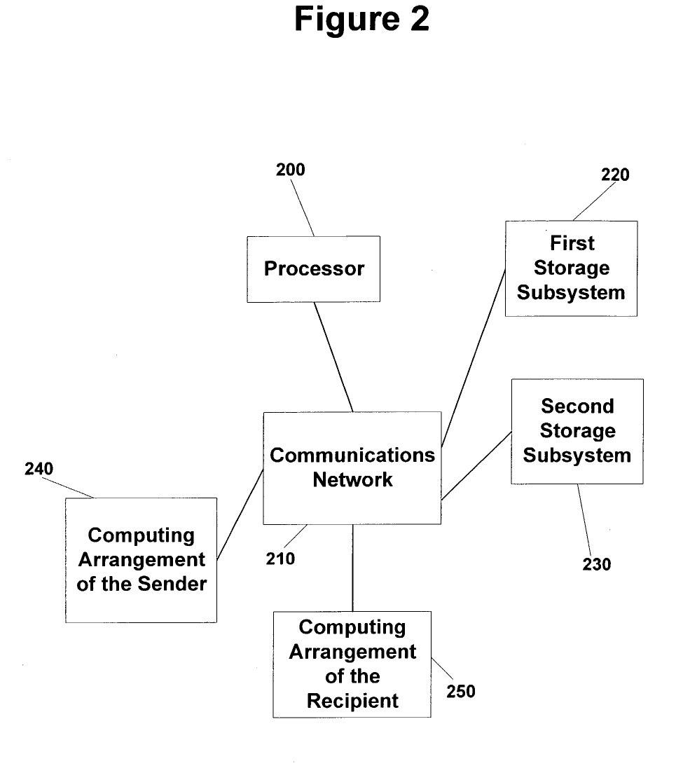

FIG. 2 shows an exemplary system according to the present invention. The system is configured to execute the method described above in reference to FIG. 1. A processor 200 executes the method according to the present invention. The processor may include a computer server arrangement. In the exemplary system according to the present invention, the method is stored as a set of instructions stored on a first storage subsystem 220 that may be a compact disk, a hard drive, DVD-ROM, CD-ROM or any type of computer-readable storing medium. The first storage subsystem 220 is included as part of the sender's computing arrangement 240. The sender of the XML document uses computing arrangement 240 to create a first set of data as a XML document and to transmit the XML document to the recipient. The computing arrangement 240 communicates with the processor 200 via a communications network 210. Before the XML document is sent to the recipient, the XML document is transferred to the processor 200 via the communications network 210. The processor 200 uses the set of instructions stored on the first storage subsystem 220 to convert the XML document into a HTML document. A second storage subsystem 230 is used to store a second set of data and a predefined set of meta-data, the second set of data includes data regarding the structure of the XML document, data regarding a storage location of the XML document, data regarding a storage location of the elements of the XML document, and data regarding the values of the elements of the XML document. The second storage subsystem 230 is included as part of the sender's computing arrangement 240. The processor 200 communicates with the second storage subsystem 230 and the first storage subsystem 220 via the communications network 210. The processor 200 uses the communications network 210 to transmit the HTML document to the computing arrangement 250 of the recipient. The two computing arrangements 240, 250 may include a personal computer, a computer network, a wireless computing device, another communications network or a wireless computing network. The recipient views the HTML document as a HTML form and manipulates the data by entering data into the HTML form. After manipulating the HTML document, the recipient transmits the HTML document back to the sender via the computing arrangement 250, the communications network 210 and the processor 200. The processor 200 traces the HTML document back into its original form as a XML document by manner of the set of instructions stored on the first storage subsystem 220. The HTML document is traced, i.e., converted, back into a XML document based on the second set of data stored on the second storage subsystem and the manipulation of the data by the recipient. The resulting XML document is returned by the processor 200 to the sender via the communications network 210 to the computing arrangement 240.

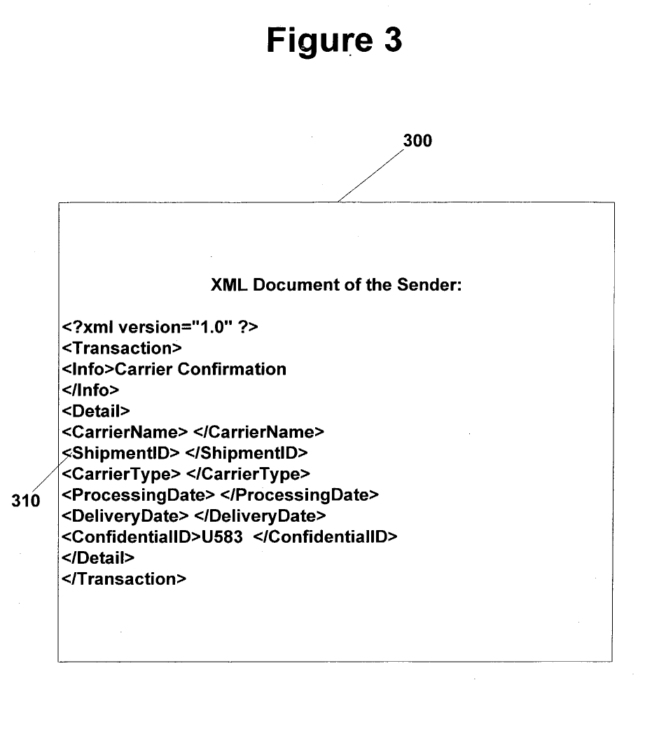

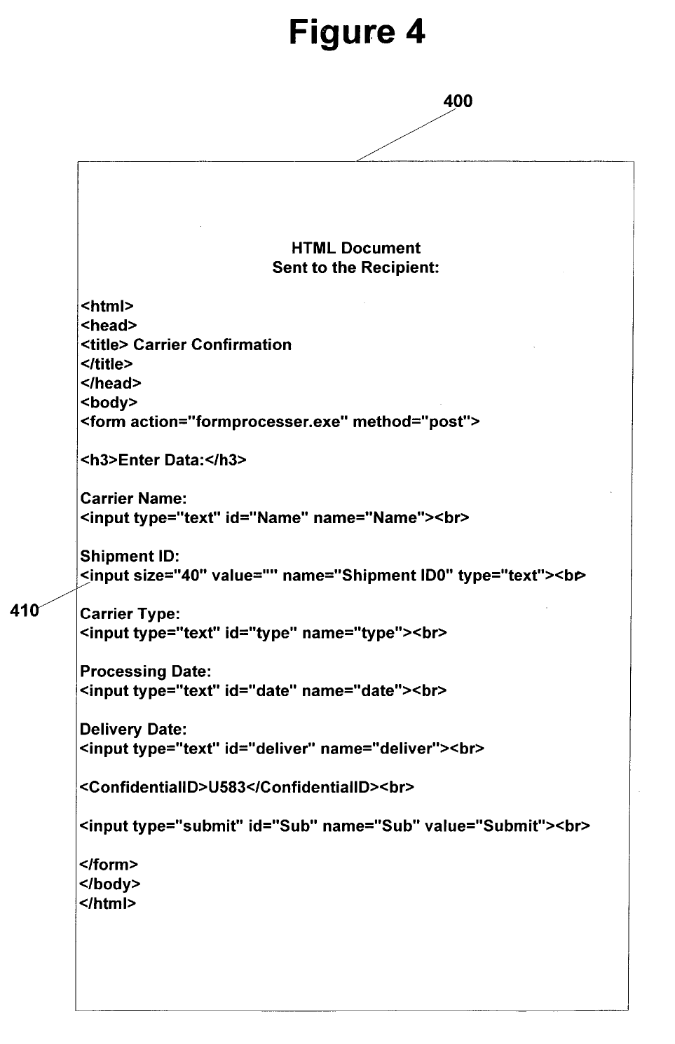

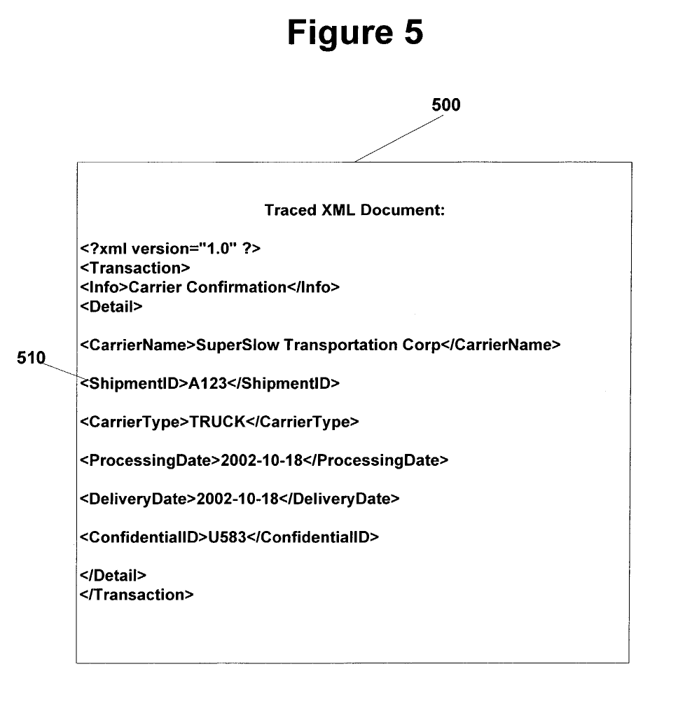

FIGS. 3, 4, and 5 show the conversion of a XML document to a HTML document and the XML document as it is traced back into XML. FIG. 3 shows an exemplary XML document prepared by a sender. FIG. 4 shows an exemplary HTML document sent to the recipient. FIG. 5 shows an exemplary traced XML document. An element ShipmentID in the XML document 300, formed by the sender, is <ShipmentID></ShipmentID> 310. The XML tag is <ShipmentID> and value of the element is “ ”. In reformatting the XML document 300 into a HTML document 400 the <ShipmentID></ShipmentID> tag 310 is converted to the following HTML tag: <input size=“40” value=“ ” name=“Shipment ID0” type=“text”> 410. This HTML tag 410 in conjunction with the set of meta-data links the value for unique key “ShipmentID0” to the ShipmentID element. After the recipient manipulates the data set within the HTML form 400 and the HTML document is traced back into a XML document, a new value “A123” 510 for the <ShipmentID> Element is sent back to the sender. By applying the unique key “ShipmentID0” in the HTML tag 410, “A123” is mapped back to ShipmentID element in the first set of data. Similar conversions are done for the rest of elements in the XML document.

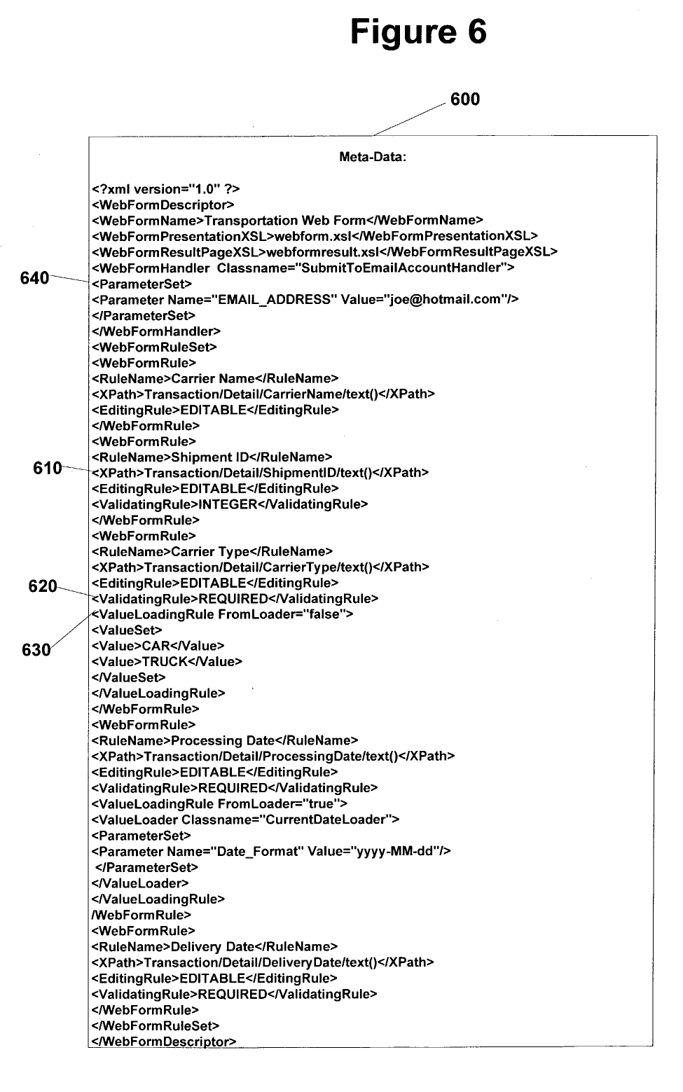

FIG. 6 shows an exemplary embodiment of the set of meta-data. The meta-data 600 is predefined and may be loaded from a separate XML document. The set of meta-data 600 provides the basis for replacing markup tags for displaying the first set of data and for replacing markup tags for setting the manner in which the data may be manipulated by the recipient. The set of meta-data 600 defines whether or not elements of the first set of data are editable. If the element is editable, the XML tag will be transformed into a HTML text field tag or into a HTML drop down list tag. If the data is not editable, the XML tag will be transformed into a HTML text tag. For the editable text field or drop down list, a unique key is inserted into the HTML as a feedback in the HTML form such that a one to one link is established between the second set of data and the HTML document displayed to the recipient. The set of meta-data 600 includes a rule 610 that corresponds to the Shipment ID element that was seen in FIGS. 3, 4 and 5. The set of meta-data 600 may also contain data regarding a validation rule 620 of the recipient input, a value loading rule 630 of the data element and a handling rule 640 for when the XML document is traced back from HTML. By attaching a different handling rule 640, the newly created XML document may be sent as email through SMTP protocol, it may also be sent as transaction through a web service interface. Typically, in a B2B application, a web service handling rule may be used to submit the new XML document to a remote web service.

FIG. 7 shows the conversion of a XML markup tag to a HTML markup tag. The conversion of the markup tags 700, 710 occurs by manner of the method described above in reference to FIG. 1. XML markup tag 700 is a XML tag for the ShipmentID element. The XML ShipmentID markup tag 700 is converted into a HTML markup tag 710 that is sent to the recipient.

What is claimed is:

1. A method for data transfer, comprising:
(a) forming a first set of data including a first plurality of data tags that configure a content of the first set of data by defining a first format for the content;
(b) forming a second set of data by referencing a set of meta-data that defines a manner in which the first set of data is displayed and is able to be manipulated, after referencing the set of meta-data, the second set of data includes the set of meta-data, a structure data of the first set of data, a first storage location data corresponding to the first set of data, a second storage location data corresponding to a plurality of elements of the first set of data, and a plurality of element values of the first set of data;
(c) storing the second set of data;
(d) replacing the first plurality of data tags with a second plurality of data tags that correspond to a second format on a basis of the second set of data;
(e) transmitting the first set of data by a sender to a recipient;
(f) manipulating the first set of data, the manipulation being defined by the recipient;
(g) transmitting the first set of data, after manipulation by the recipient, to the sender; and
(h) reforming the first set of data with the first plurality of data tags by referencing the set of meta-data and on a basis of the manipulation by the recipient;
wherein the first plurality of data tags and the first format conform to the Extensible Markup Language (XML) standard and the second plurality of data tags and the second format conform to the Hypertext Markup Language (HTML) standard.

2. The method of claim 1, wherein the second plurality of data tags include an identification data tag that establishes a one-to-one correspondence between the second set of data and the first set of data transmitted to the recipient.

3. The method of claim 1, wherein the transmission step (e) and the transmission step (g) are performed using a computing arrangement in communication with a processor via a communications network.

4. The method of claim 3, wherein the processor includes a computer server arrangement.

5. A computer-readable storing medium storing a set of instructions, the set of instructions capable of being executed by a processor to implement a method for data transfer, the set of instructions performing the steps of:
(a) forming a first set of data including a first plurality of data tags that configure a content of the first set of data by defining a first format for the content;
(b) forming a second set of data by referencing a set of meta-data that defines a manner in which the first set of data is displayed and is able to be manipulated, after referencing the set of meta-data, the second set of data includes the set of meta-data, a structure data of the first set of data, a first storage location data corresponding to the first set of data, a second storage location data corresponding to a plurality of elements of the first set of data, and a plurality of element values of the first set of data;
(c) storing the second set of data;
(d) replacing the first plurality of data tags with a second plurality of data tags that correspond to a second format on a basis of the second set of data;
(e) transmitting the first set of data by a sender to a recipient;
(f) manipulating the first set of data, the manipulation being defined by the recipient;
(g) transmitting the first set of data, after manipulation by the recipient, to the sender; and
(h) reforming the first set of data with the first plurality of data tags by referencing the set of meta-data and on a basis of the manipulation by the recipient;
wherein the first plurality of data tags and the first format conform to the Extensible Markup Language (XML) standard and the second plurality of data tags and the second format conform to the Hypertext Markup Language (HTML) standard.

6. The computer-readable storing medium of claim 5, wherein the second plurality of data tags include an identification data tag that establishes a one-to-one correspondence between the second set of data and the first set of data transmitted to the recipient.

7. The computer-readable storing medium of claim 5, wherein the transmission step (e) and the transmission step (g) are performed using a computing arrangement in communication with the processor via a communications network.

8. The computer-readable storing medium of claim 7, wherein the processor includes a computer server arrangement.

9. A system comprising:
a processor;
at least one computing arrangement configured to communicate with the processor via a communications network; and
a computer-readable storing medium storing a set of instructions, the set of instructions capable of being executed by the processor to implement a method for data transfer, the set of instructions performing the steps of:
(a) forming a first set of data including a first plurality of data tags that configure a content of the first set of data by defining a first format for the content;
(b) forming a second set of data by referencing a set of meta-data that defines a manner in which the first set of data is displayed and is able to be manipulated, after referencing the set of meta-data, the second set of data includes the set of meta-data, a structure data of the first set of data, a first storage location data corresponding to the first set of data, a second storage location data corresponding to a plurality of elements of the first set of data, and a plurality of element values of the first set of data;
(c) storing the second set of data;
(d) replacing the first plurality of data tags with a second plurality of data tags that correspond to a second format on a basis of the second set of data;
(e) transmitting the first set of data by a sender to a recipient;
(f) manipulating the first set of data, the manipulation being defined by the recipient;
(g) transmitting the first set of data, after manipulation by the recipient, to the sender; and
(h) reforming the first set of data with the first plurality of data tags by referencing the set of meta-data and on a basis of the manipulation by the recipient;
wherein the first plurality of data tags and the first format conform to the Extensible Markup Language (XML) standard and the second plurality of data tags and the second format conform to the Hypertext Markup Language (HTML) standard.

10. The system of claim 9, wherein the second plurality of data tags include an identification data tag that establishes a one-to-one correspondence between the second set of data and the first set of data transmitted to the recipient.

11. The system of claim 9, wherein the transmission step (e) and the transmission step (g) are performed using a computing arrangement in communication with the processor via a communications network.

12. The system of claim 11, wherein the processor includes a computer server arrangement.
